(19) United States
(12) Patent Application Publication
(10) Pub. No.: US 2010/0270932 A1
(43) Pub. Date: Oct. 28, 2010

(54) FAULT DETECTION AND SHUTDOWN CONTROL CIRCUITS AND METHODS FOR ELECTRONIC BALLASTS

(76) Inventors: Naoki Onishi, Kobe (JP); Hiroyuki Asano, Kashiba (JP); Tetsuya Hamana, Nara (JP); Masahiro Yamanaka, Otsu (JP)

Correspondence Address: WADDEY & PATTERSON, P.C., 1600 DIVISION STREET, SUITE 500, NASHVILLE, TN, 37203, US

(21) Appl. No.: 12/767,540

(22) Filed: Apr. 26, 2010

(30) Foreign Application Priority Data
Apr. 24, 2009 (JP) 2009107072

(51) Int. Cl. H05B 41/36

(52) U.S. Cl. 315/119

(57) ABSTRACT

An electronic ballast is capable of inhibiting ballast shutdown caused by erroneously determining a fault condition. The ballast includes a DC power supply circuit for outputting DC power, a power conversion circuit that appropriately converts DC power outputted by the DC power supply circuit and outputs it to a discharge lamp, a DC voltage droop detection circuit for determining existence/absence of a fault condition in the DC power supply circuit 1, a lamp end of life detection circuit for determining existence/absence of a fault condition of the discharge lamp; and a sequence control circuit and a shutdown control circuit that control at least the power conversion circuit according to detection by the DC voltage droop detection circuit the discharge lamp life detection circuit. When a fault is determined in both the DC voltage droop detection circuit and the discharge lamp life detection circuit, an operation according to the detection of the DC voltage droop detection circuit, the sequence control circuit lowers the output of the power conversion circuit 2 is performed in priority to an operation that, according to the detection of the discharge lamp life detection circuit, the shutdown control circuit shuts down the power conversion circuit

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application which is hereby incorporated by reference: Japan Patent Application No. 2009-107072, filed Apr. 24, 2009.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to electronic ballasts for providing operating power to gas discharge lamps. More particularly, the present invention pertains to fault detection and shutdown control circuits and methods for electronic ballasts.

Conventional electronic ballasts include a DC power supply circuit that is supplied with power from an external AC power supply and outputs DC power to a power conversion circuit that appropriately converts the DC power from the DC power circuit and provides it to a load. The load may be, for example, a gas discharge lamp and the power conversion circuit may be an inverter circuit.

Furthermore, conventional power supply devices and electronic ballasts may include a supply side fault detection circuit for detecting the existence/absence of a fault condition in the DC power supply circuit and a load side fault detection circuit for detecting the existence/absence of a fault condition in the power conversion circuit or the load. One fault condition determined by the supply side fault detection circuit, for example, may be a low output voltage from the DC power supply circuit. A fault condition determined by the load side fault detection circuit may be an unloaded condition where the load is not correctly connected to the power conversion circuit.

Regarding the detection of a fault by the supply side fault detection circuit, because many of the fault conditions are resolved in a short time such as one that is caused by temporary decrease of input power to the DC power supply circuit, it is desirable that the supply side fault detection circuit not immediately disable the output of the power supply circuit.

However, because the power conversion circuit is provided in a subsequent stage to the DC power supply circuit, when a fault condition is determined by the supply side fault detection circuit, a fault condition is also erroneously determined by the load side fault detection circuit. Further, when the load side fault detection circuit determines the fault condition, and the DC power supply circuit and the power conversion circuit are shut down, there is a possibility that the output power of the power conversion circuit will not be decreased because the operation is stopped due to the erroneous detection as described above.

### BRIEF SUMMARY OF THE INVENTION

The present invention has an object to provide an electronic ballast capable of avoiding a ballast shutdown caused by erroneously determining a fault condition.

A the first aspect of the invention has a DC power supply circuit that is supplied with electric power from an external power supply and outputs DC power and a power conversion circuit that appropriately converts the DC power from the DC power supply circuit and outputs it to a load. A supply side fault detection circuit determines the existence/absence of a fault condition in the DC power supply circuit. A load side fault detection circuit determines the existence/absence of a fault condition in the power conversion circuit or the load. A control circuit controls the power conversion circuit according to detection by the supply side fault detection circuit and/or detection by the load side fault detection circuit. The control circuit causes a decrease in output power from the power conversion circuit to the load to be less than that during normal operation, before starting regular operation at a starting time. When the supply side fault detection circuit determines the fault condition, the control circuit performs a repeated starting operation for a predetermined time, and, when the load side fault detection circuit determines the fault condition, and only if the supply side fault detection circuit does not determine the fault condition, the control circuit stops or shuts down at least the output of the power conversion circuit.

According to the present invention, priority will be given to an operation that starts the repeated starting operation based on the detection of a fault condition by the supply side fault detection circuit rather than an operation that stops the power conversion circuit based on detection of a fault condition by the load side fault detection circuit. Therefore, a shutdown of the power conversion circuit caused by a fault condition that is erroneously determined in the load side fault detection circuit, in combination with a fault of the DC power supply circuit, is inhibited.

According to a second aspect of the invention, when the supply side fault detection circuit determines a fault condition at the time of completion of the repeated starting operation after the supply side fault detection circuit determines the fault condition, the control circuit stops the output of the supply side fault detection circuit.

According to the present invention, useless consumption of electric power by a fault condition that is not eliminated during the repeated starting operation can be avoided.

According to a third aspect of the present invention, the control circuit counts the number of times of performing the repeated starting operations, and, if the supply side fault detection circuit determines the fault condition after the number of times of starting the repeated starting operation reaches a predetermined upper limit, the control circuit stops at least the output of the power conversion circuit without starting the repeated starting operation.

According to the first aspect of the invention, because a priority is assigned to an operation that starts the repeated starting operation based on the detection of a fault condition by the supply side fault detection circuit rather than the operation that stops the power conversion circuit based on the detection of the fault condition by the load side fault detection circuit, the shut down of the power conversion circuit resulting from an erroneously determined fault condition in the load side fault detection circuit, combined with a fault of the DC power supply circuit, is inhibited.

According to the second aspect of the invention, after the supply side fault detection circuit determines a fault condition, if the supply side fault detection circuit still determines the fault condition at the time of completion of the repeated starting operation, the control circuit stops at least the output of the power conversion circuit. Therefore, it is possible to avoid useless consumption of electric power by a fault condition that is not eliminated during the repeated starting operation.

### BRIEF DESCRIPTION OF THE SEVERAL VIEWS OF THE DRAWINGS

FIG. 1 is a circuit block diagram showing a first embodiment of the present invention.

FIG. 2 is a circuit block diagram showing a starting circuit and a control power supply circuit in a drive IC according to a first embodiment.

FIGS. 3(a) to 3(f) are explanatory diagrams showing one example of operation of the first embodiment, in which (a) shows a temporal variation in the output voltage of the DC power supply circuit, (b) shows temporal variations of a detection voltage and a driving voltage, respectively, when the drive voltage is divided, (c) shows a temporal variation in the gate voltage of the first switch in the starting circuit, (d) shows a temporal variation in a control voltage, (e) shows a temporal variation in an output voltage of the shutdown execution circuit, and (f) shows a temporal variation in voltage of a drive signal from a drive circuit to either of the switches elements of the power conversion circuit.

FIG. 4 is a circuit block diagram showing an oscillation circuit, drive circuit, and shutdown execution circuit in a drive IC according to a first embodiment.

FIGS. 5(a) to 5(d) are explanatory diagrams showing operation of the oscillation circuit of the first embodiment, in which FIG. 5(a) shows a temporal variation in voltage across the oscillation capacitor in the oscillation circuit, FIG. 5(b) shows a temporal variation in output voltage of a comparator in the oscillation circuit, FIG. 5(c) shows a temporal variation in voltage value of a first rectangle signal, and FIG. 5(d) shows a temporal variation in a voltage value of a first driving signal.

FIGS. 6(a) to 6(g) are diagrams showing one example of operation of the first embodiment, in which (a) shows a temporal variation in the control voltage, (b) shows a temporal variation in an input voltage to the shutdown execution circuit, (c) shows a temporal variation in an output voltage of the shutdown execution circuit, (d) shows a temporal variation in an output voltage of a sequence control circuit, (e) shows a temporal variation in a voltage across the control capacitor, (f) shows a temporal variation in an operating frequency, and (g) shows a temporal variation in a clock frequency.

FIG. 7 is a circuit block diagram showing a principal circuit according to a first embodiment.

FIG. 8 is a circuit diagram showing a DC voltage droop detection circuit according to a first embodiment.

FIGS. 9(a) to 9(f) are explanatory diagrams showing an operation when a duration of a DC voltage droop state does not amount to a restart time in the first embodiment, in which (a) shows a temporal variation in an output voltage of the DC power supply detection circuit, (b) shows a temporal variation in an output voltage of the comparator of the DC voltage droop detection circuit, (c) shows a temporal variation in an output voltage of the DC voltage droop detection circuit, (d) shows a temporal variation in an output voltage of the sequence control circuit, (e) shows a temporal variation in the operating frequency, and (f) shows a temporal variation in an output voltage of the shutdown control circuit in an integrated drive circuit.

FIGS. 10(a) to 10(f) are diagrams showing an operation when the duration of the DC voltage droop state amounts to the restart time in the first embodiment, in which (a) shows a temporal variation in the output voltage of the DC power supply detection circuit, (b) shows a temporal variation in the output voltage of the comparator of the DC voltage droop detection circuit, (c) shows a temporal variation in the output voltage of the DC voltage droop detection circuit, (d) shows a temporal variation in the output voltage of the sequence control circuit, (e) shows a temporal variation in the operating frequency, and (f) shows a temporal variation in the output voltage of the shutdown control circuit to the integrated circuit for drive.

FIG. 11 is a circuit block diagram showing a principal circuit in a modification of the first embodiment.

FIGS. 12(a) to 12(g) are diagrams showing an operation of a zero current detection circuit used with the modified embodiment of FIG. 11, in which (a) shows a temporal variation in an output voltage of the power supply drive circuit, (b) shows a temporal variation in an input voltage to the zero current detection circuit, (c) shows a temporal variation in an output voltage of the input comparator of the zero current detection circuit, (d) shows a temporal variation in voltage across the capacitor for holding the zero current detection circuit, (e) shows a temporal variation in an output voltage of a one shot circuit, (f) shows a temporal variation in an output voltage of an output comparator of the zero current detection circuit, and (g) shows a temporal variation in an output voltage of the zero current detection circuit.

FIG. 13 is a block diagram showing a second embodiment of the present invention.

FIG. 14 is a circuit block diagram showing a power supply detection circuit and a shutdown execution circuit according to a second embodiment.

FIGS. 15(a) to 15(f) are explanatory diagrams showing one example of operation of the second embodiment, in which (a) shows a temporal variation in output of the shutdown control circuit, (b) shows a temporal variation in an output voltage of the power supply detection circuit, (c) shows a temporal variation in an output of the input comparator connected to the power supply detection circuit in the shutdown execution circuit, (d) shows a temporal variation in an output of an OR gate of the shutdown execution circuit, (e) shows a temporal variation in the voltage across a delay capacitor, and (f) shows a temporal variation in an signal voltage.

FIGS. 16(a) to 16(f) are diagrams showing one example of the operation of the second embodiment, in which (a) shows a temporal variation in the control voltage, (b) shows a temporal variation in the output voltage of the shutdown control circuit, (c) shows a temporal variation in the output voltage of the shutdown execution circuit, (d) shows a temporal variation in the output voltage of the sequence control circuit, (e) shows a temporal variation in the voltage across a control capacitor, and (f) shows a temporal variation in the operating frequency.

FIG. 17 is a circuit block diagram showing a third embodiment of the present invention.

FIG. 18 is a circuit block diagram showing a principal circuit of the third embodiment.

FIG. 19 is a circuit block diagram showing a principal circuit of a modification of the third embodiment.

### DETAILED DESCRIPTION OF THE INVENTION

Hereafter, various embodiments of the present invention will be explained with reference to drawings.

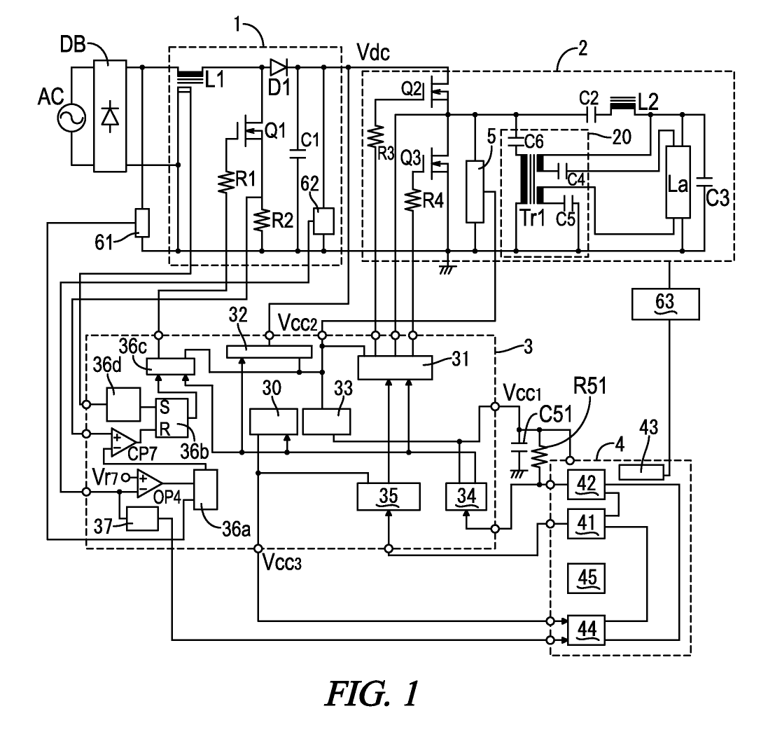

The present embodiment may be an electronic ballast used to provide operating power to a gas discharge lamp La having a pair of filaments (not illustrated) by supplying AC power thereto, as shown in FIG. 1. The ballast has a rectification circuit DB using a well-known diode bridge and performs full-wave rectification of AC power from an external AC power supply AC. A DC power supply circuit 1 receives the output of the rectification circuit DB and outputs DC power. A power conversion circuit 2 that converts the DC power from the DC power supply circuit 1 into AC power and supplies it to the discharge lamp La.

The DC power supply circuit 1 is a well-known booster chopper circuit (boost converter). More specifically, the DC power supply circuit 1 includes series circuit of an inductor L1 connected between the DC outputs of the rectification circuit DB (namely, between a DC output end of a high-voltage side of the rectification circuit DB and ground), a diode D1, and an output capacitor C1. A series circuit of a switch Q1 having a first end connected to a junction point of the inductor L1 and the diode D1 and a second connected to ground and a resistor R5, and outputs a voltage across the output capacitor C1 as an output voltage. The output voltage thereof is controlled by an on-time of switch Q1 that is periodically turned on and off. The DC output end of a low-voltage side of the rectification circuit DB and the output end of a low-voltage side of the DC power supply circuit 1 are connected to ground, respectively.

The power conversion circuit 2 is a well-known, half-bridge type inverter circuit that includes a series circuit of two switches Q2, Q3 connected between the output ends of the DC power supply circuit 1. A series circuit includes a capacitor C2 and an inductor L2 having one end connected to a junction point of the switches Q2, Q3 and another end connected to ground through the discharge lamp La. A capacitor C3 is connected to the discharge lamp La in parallel (namely, between filaments of the discharge lamp La). That is, by the switches Q2, Q3 being turned on and off alternately, AC power is provided to the discharge lamp La. Moreover, the capacitor C2, inductor L2 and capacitor C3 constitute a resonant circuit together with the discharge lamp La, and depending on a relation between the resonant frequency of the resonant circuit and the of/off drive frequency of the switches Q2, Q3, the power supplied to the discharge lamp increases or decreases.

Furthermore, the present embodiment may include a preheating circuit 20 for preheating the filaments of the discharge lamp La, respectively, at a starting time of the discharge lamp La. The preheating circuit 20 includes a primary winding having a first end connected to a junction point of the switches Q2, Q3 of the power conversion circuit 2 through a capacitor C6, and a second end connected to ground, and a transformer Tr1 having two secondary winding such that each series circuit consisting of either winding and either of capacitors C4, C5 is connected to each of the filaments of the discharge lamp La.

Furthermore, the present embodiment may include a drive circuit 31 that is connected to the switches Q2, Q3 through respective resistors R1, R2 and supplies AC power from the power conversion circuit 2 to the discharge lamp La by on/off driving of the respective switches Q2, Q3 of the power conversion circuit 2. A sequence control circuit 41 controls the frequency of the AC power from the power conversion circuit 2 to the discharge lamp La by controlling the frequency of operation of the drive circuit 31.

The drive circuit 31 may be provided in a drive integrated circuit (IC) 3 formed as a high-voltage integrated circuit (HVIC). The sequence control circuit 41 is provided in a control IC, microcontroller, or microprocessor 4. The control IC 4 may be one that has only binary input/output and includes neither an A/D converter nor a D/A converter and therefore will have lower power consumption.

Moreover, the present embodiment may be equipped with a drive power supply circuit 5 that is supplied with power from the power conversion circuit 2 after start-up of the drive circuit 31, and outputs DC power that serves as a power supply for the drive IC 3. The drive power supply circuit 5 has an output side capacitor (not illustrated) and a charging circuit (not illustrated) that are connected to the junction point of the switches Q2, Q3 of the power conversion circuit 2 and charges the output side capacitor. The output voltage thereof is the voltage between across the output side capacitor. In a state where the voltage across the output side capacitor is stabilized after the sufficient time has elapsed from startup of drive circuit 31, the voltage across the output side capacitor, i.e., the output voltage of the drive power supply circuit 5 becomes, for example, 10V.

Furthermore, the drive IC 3 may be provided with a starting circuit 32 that is supplied with power from the DC power supply circuit 1 and outputs DC power that serves as a power supply to the drive power supply circuit 5 before start-up of the drive circuit 31; and a control power supply circuit 33 that is supplied with power from the drive power supply circuit 5 and, in a period of time when the output voltage of the drive power supply circuit 5 is equal to or greater than a predetermined voltage, generates DC power of, for example, 5V that serves as a power supply for control IC 4 and supplies it to control IC 4, respectively.

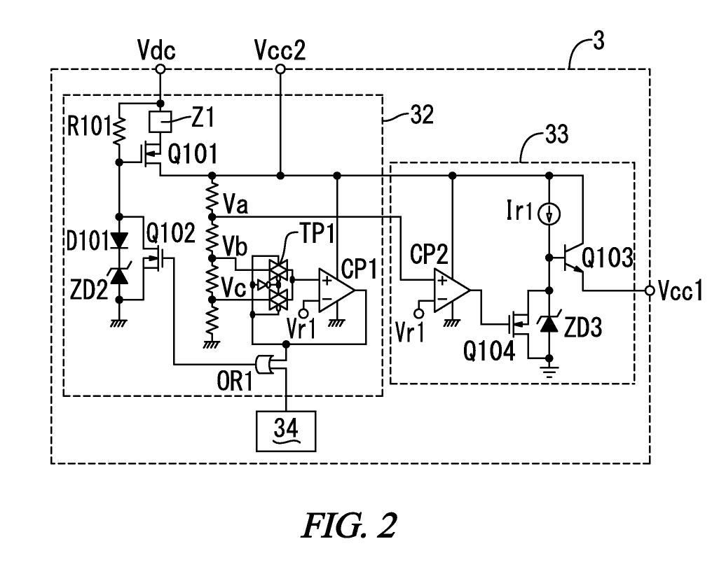

As shown in FIG. 2, the starting circuit 32 may include an impedance component Z1 having one end connected to a high-voltage output end of the DC power supply circuit 1 and the other end connected to an output end of the drive power supply circuit 5 through a first switch Q101. That is, in a period of time when first switch Q101 of the starting circuit 32 is turned on, an output voltage Vdc of the DC power supply circuit 1 is provided to the drive power supply circuit 5 through the impedance element Z1 and the first switch Q101, and thereby an output capacitor of the drive power supply circuit 5 is charged. The above first switch Q101 may be n-type channel high-voltage field effect transistor, and the gate of the first switch Q101 is connected to a junction point of the DC power supply circuit 1 and the impedance element Z1 through a resistor R101, and is also connected to ground through a parallel circuit consisting of a series circuit of a diode D101, a zener diode ZD2 and a second switch Q102 that may be an n-type channel field effect transistor. Moreover, the starting circuit 32 may have four voltage dividing resistors that divide an output or drive voltage Vcc2 of the drive power supply circuit 5, respectively. Three different detection voltages Va, Vb, and Vc that are different in voltage according to a voltage dividing ratio are provided from the junction points of the voltage dividing resistors.

Furthermore, the starting circuit 32 may have a comparator CP1 having an inverting input connected to a predetermined reference voltage Vr1 and an output connected to the gate of second switch Q102 through an OR gate OR1. The detection voltages Vb, Vc are provided to a non-inverting input of comparator CP1 through a multiplexer TG1 constructed with a transfer gate circuit. The multiplexer TG1 is connected to the output of comparator CP1, and is configured so as to, in a period of time when an output of comparator CP1 is high, provides a detection voltage that is a second lowest detection voltage (hereinafter called the “second detection voltage”) Vb to the non-inverting input of comparator CP1. In the period when the output of comparator CP1 is low, the multiplexer TG1 provides the lowest detection voltage (hereinafter called the “third detection voltage) Vc to the non-inverting input of comparator CP1.

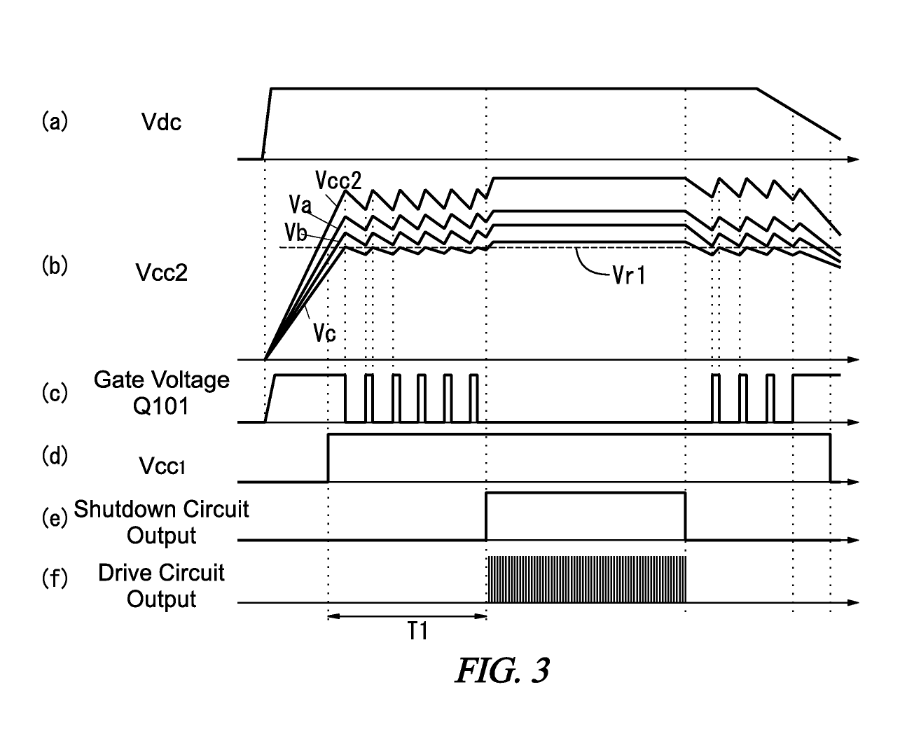

Operation of the starting circuit 32 will be explained with reference to FIG. 3. Immediately after the ballast or power supply is turned on, because the output of comparator CP1 is low, the third detection voltage Vc is provided to the non-inverting input of comparator CP1 and second switch Q102 is turned off, which makes first switch Q101 turn on by a zener voltage of the Zener diode ZD2. In a period of time when first switch Q101 is being turned on, the output side capacitor of the drive power supply circuit 5 is charged by output power of the DC power supply circuit 1 being supplied through the impedance component Z1 and the first switch Q101 of the starting circuit 32, and thereby driving voltage Vcc2 increases gradually.

When the third detection voltage Vc reaches the first reference voltage Vr1 in a short time, the output of comparator CP1 becomes high. Then, an input voltage to the non-inverting input changes to the second detection voltage Vb that is higher than the third detection voltage Vc, and second switch Q102 is turned on and first switch Q101 is turned off, which causes a shutdown of the starting circuit 32 to the drive power supply circuit 5. At this time, because the drive circuit 31 does not yet start the starting operation and power is not supplied from the power conversion circuit 2 to the drive power supply circuit 5, the driving voltage Vcc2 starts to decrease by discharge of the output capacitor. When the second detection voltage Vb reaches the first reference voltage Vr1, the output of comparator CP1 becomes low again, the output voltage of the drive power supply circuit 5 starts to increase, and when the third detection voltage Vc reaches the first reference voltage Vr1, the output of the comparator CP1 becomes high again. After this, in a period of time when DC power as shown in FIG. 3(a) is supplied from the DC power supply circuit 1, the input from a shutdown execution circuit 34 (that will be described below) shown in FIG. 3(e) to the OR gate OR1 is low, and the drive circuit 31 is in shutdown, by repetition of the above-mentioned operation, the gate voltage of the first switch Q101 varies as shown in FIG. 3(c), and the driving voltage Vcc2 transition between an upper limit voltage that equalizes the third detection voltage Vc to the first reference voltage Vr1 and a lower limit voltage that equalizes the second detection voltage Vb to the first reference voltage Vr1, as shown in FIG. 3(b).

The drive IC 3 may be provided with a shutdown execution circuit 34 for controlling the drive circuit 31 and the starting circuit 32, respectively. An output of the shutdown execution circuit 34 is provided to the OR gate OR1. In a period of time when the output of the shutdown execution circuit 34 is low, the drive circuit 31 is shut down and power supply from the starting circuit 32 to the drive power supply circuit 5 is turned on. However, in a period of time when the output of the shutdown execution circuit 34 is high, regardless of the output of the comparator CP1, by the second switch Q102 being turned on and by the first switch Q101 being turned off, the power supply from the starting circuit 32 to the drive power supply circuit 5 is turned off. However, in a period of time when the output of the shutdown execution circuit 34 is high, by the drive circuit 31 performing an operation (namely, generating outputs for driving the switches Q2, Q3 as shown in FIG. 3(f)), power supply from the power conversion circuit 2 to the drive power supply circuit 5 is enabled.

Moreover, the drive IC 3 may include a control power supply circuit 33 that is supplied with power from the drive power supply circuit 5 and in a period of time when the output voltage of the drive power supply circuit 5 is equal to or greater than a predetermined reference voltage, generates a DC current of a predetermined voltage (hereinafter called a “control voltage”) Vcc1 that serves as a power supply for the control IC. The control power supply circuit 33 may include a comparator CP2 having a non-inverting input coupled to the highest or first detection voltage Va from the voltage dividing resistors of the starting circuit 32 and an inverting input coupled to a first reference voltage Vr1. A series circuit of a constant current circuit Ir1 is connected between the output end of the drive power supply circuit 5 and ground through a zener diode ZD3 and an npn-type transistor switch Q103 whose base is connected to a junction point of the constant current circuit Ir1 and the Zener diode ZD3. The collector of switch Q103 is connected to an output end of the drive power supply circuit 5, and the emitter, as an output end of the control power supply circuit 33, is connected to control IC 4. A switch Q104 that may be an n-type channel field effect transistor, is connected in parallel with the Zener diode ZD3 and has its gate connected to the output of the comparator CP2. That is, the control power supply circuit 33 is configured so that only in a period of time when the first detection voltage Va exceeds the first reference voltage Vr1, the control voltage Vcc1 is provided to the control IC 4, and in a period of time when the first detection voltage Va is less than the first reference voltage Vr1, the control voltage Vcc1 is not provided (the output voltage of the control power supply circuit 33 becomes almost zero), as shown in FIG. 3(d), and the drive voltage when the first detection voltage Va becomes equal to the first reference voltage Vr1 is the above-mentioned reference voltage. Here, a circuit on which the control voltage Vcc1 is provided from the drive IC 3 to the control IC 4 is connected to ground through a capacitor C51 for noise rejection.

Moreover, the drive IC 3 is provided with an oscillation circuit 35 for outputting a square wave of a frequency according to an output of the sequence control circuit 41, and the drive circuit 31 performs on/off driving of the two switches Q2, Q3 of the power conversion circuit 2 at a frequency of the output of the oscillation circuit 35. Furthermore, the drive IC 3 is provided with a drive power supply circuit 30 that is controlled by the shutdown execution circuit 34, outputs a predetermined signal voltage Vcc3 when the drive circuit 31 is in operation, and on the other hand stops the output when the drive circuit 31 is in operation. The drive power supply circuit 30 can have a same circuit configuration as, for example, that of the control power supply circuit 33. The signal voltage Vcc3 is provided also to control IC 4 to inform the control IC 4 of the operation state of the drive circuit 31. Moreover, the oscillation circuit 35 uses the above-mentioned signal voltage Vcc3 as its power supply. That is, the shutdown execution circuit 34 stops the oscillation circuit 35 and the drive circuit 31, respectively, by shut down of supply of power from the signal power supply circuit 30 to the oscillation circuit 35.

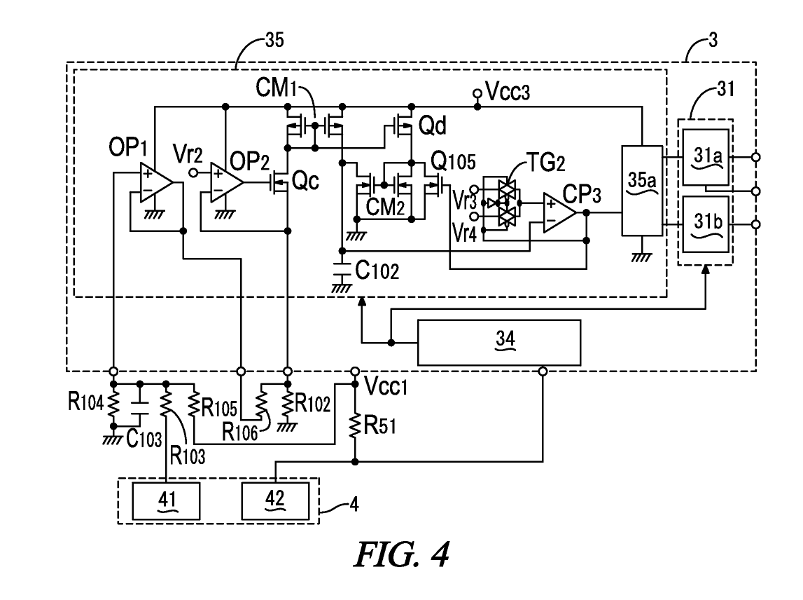

As shown in FIG. 4, the oscillation circuit 35 may be provided with a voltage follower operational amplifier OP1 having a non-inverting input connected to the sequence control circuit 41 through a resistor R103, an inverting input connected to ground through a parallel circuit of a resistor 104 and a control capacitor C103, an output connected to its inverting terminal and to ground through two resistors R106, R102. The oscillation circuit 35 may further include operational amplifier OP2 whose non-inverting input is provided with a predetermined second reference voltage Vr2 and whose inverting input is connected to an output of the voltage follower OP1 through the resistor R106. The output of operational amplifier OP2 is connected to a gate of charging switch Qc that is connected between one output end of a charging current mirror circuit, each input end of which is provided with the signal voltage Vcc3, respectively, and the resistor R102. The other output end of the current mirror circuit CM1 is connected to ground through oscillation charging capacitor C102.

Moreover, the oscillation circuit 35 may be provided with a discharging current mirror circuit CM2 having one coupled to signal voltage Vcc3 through a first discharging switch Qd. Switch Qd may be p-type channel field effect transistor with its gate connected to one output end of the current mirror circuit CM1. The oscillation C102 is connected to the other end of current mirror circuit CM1 and each of its output ends is connected to ground, respectively.

Furthermore, the oscillation circuit 35 is may include a comparator CP3 with its inverting input connected to the oscillation capacitor C102 and its non-inverting input coupled to either of a predetermined third reference voltage Vr3 and a predetermined fourth reference voltage Vr4 lower than the third reference voltage Vr3, provided though a multiplexer TG2 constructed with a transfer gate circuit. The output of the comparator CP3 is connected to the multiplexer TG2, and is configured that, in a period of time when the output of the comparator CP3 is high, the third reference voltage Vr3 is provided to a non-inverting input of the comparator CP3, and in a period of time when the output of the comparator CP3 is low, the fourth reference voltage Vr4 is provided to the non-inverting input of the comparator CP3. Moreover, a second discharging switch Q105, which may be an n-type channel field effect transistor, has its gate connected to the output of the comparator CP3 and to the discharging current mirror circuit CM2 in parallel.

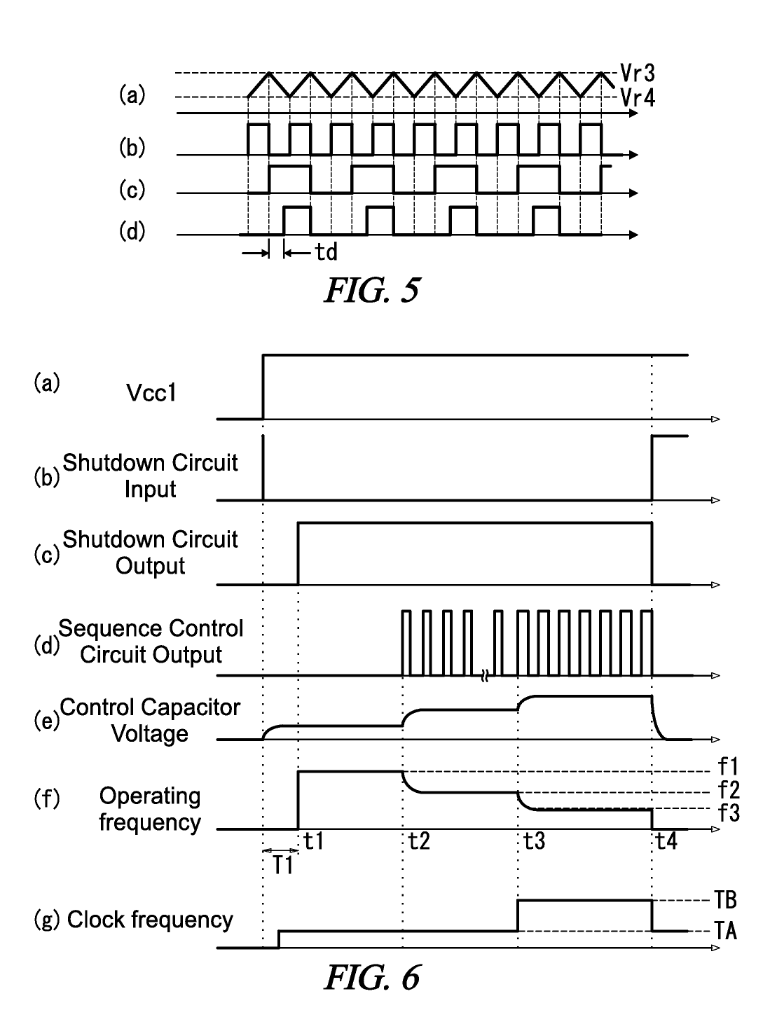

Operation of the oscillation circuit 35 may now be explained. In a state where the oscillation capacitor C102 is not sufficiently charged, by the output of the comparator CP3 becoming high, the third reference voltage Vr3 is provided to the non-inverting input of the comparator CP3, and the switch Q105 is turned on. During this period, turning-on of the second discharging switch Q105 connected to the discharging current mirror CM2 in parallel inhibits discharging of the oscillation capacitor C102 through the discharging current mirror circuit CM2, and the voltage across the oscillation capacitor C102 increases gradually by charging through the charging mirror circuit CM1. Within a short time, when the voltage across the oscillation capacitor C102 reaches the third reference voltage Vr3, the output of the comparator CP3 becomes low and an input voltage to the non-inverting input of the comparator CP3 reaches the fourth reference voltage Vr4, and at the same time the second discharging switch Q105 is turned off. Then, by the discharge current through the discharging current mirror circuit CM2 becoming larger than a charge current through the charging mirror circuit CM1, the voltage across the oscillation capacitor C102 decreases gradually. When the voltage across the oscillation capacitor C102 reaches the fourth reference voltage Vr4, the output of the comparator CP3 becomes high again, and similar operations are thereafter repeated. The voltage across the oscillation capacitor C102, i.e., an input voltage to an inverting input of the comparator CP3, repeatedly transitions between the third reference voltage Vr3 and the fourth reference voltage Vr4, as shown in FIG. 5(a), and the output of the comparator CP3 becomes a square wave as shown in FIG. 5(b). Furthermore, the oscillation circuit 35 has an output shaping circuit 35a that shapes the output of the comparator CP3 and provides it to the drive circuit 31. As shown in FIG. 5(c), the output shaping circuit 35a has a first rectangular signal generation circuit (not illustrated) for generating a first rectangular signal by frequency-dividing the output of the comparator CP3 by two, a second rectangular signal generation circuit (not illustrated) for generating a second rectangular signal that is the first rectangular signal whose output is inverted; and a dead time generation circuit (not illustrated) that generates a first driving signal as shown in FIG. 5(d) by delaying the on time (inversion from low to high) of the first rectangular signal by a predetermined dead time td, generates a second driving signal by delaying the on time of the second rectangular signal in the same manner as described above, and outputs the first driving signal and the second driving signal to the drive circuit 31, respectively.

The drive circuit 31 has a first drive circuit 31a that turns on one switch Q2 of the power conversion circuit 2 in an on period of the first driving signal (a high period) and turns it off in an off period of the first driving signal (a low period, and a second drive circuit 31b that turns on the other switch Q3 of the power conversion circuit 2 in an on period of the second driving signal and turns it off in an off period of the second driving signal. That is, the two switches Q2, Q3 of the power conversion circuit 2 are prevented from being turned on simultaneously by the dead time generation circuit. Because a high capacitance value is not required of the oscillation capacitor C102 in the above-mentioned configuration, the oscillation capacitor C102 can be configured to be in the control IC 4.

The charging current and discharge current of the oscillation capacitor C102 become smaller, respectively, with increasing input voltage to the inverting input of the control operational amplifier OP2, namely, with increasing voltage across the control capacitor C103. That is, the frequency of first driving signal and second driving signal, i.e., a frequency of the drive circuit 31 that is the frequency of the AC power outputted to the discharge lamp La, (hereafter called an “operating frequency”) becomes lower with increasing voltage across the control capacitor C103.

The sequence control circuit 41 of the control IC 4 performs the starting operation from t2 to t3 to start the discharge lamp La after a lamp filament preheating operation from t1 to t2, respectively, by making the voltage across the control capacitor C103 shown in FIG. 6(e) vary according to a time after the supply of the control voltage Vcc1 shown in FIG. 6(a) was started, and subsequently shifts to a regular operation from t3 to t4 of maintaining stable lighting of the discharge lamp La. For example, the sequence control circuit 41 outputs a PWM signal as shown in FIG. 6(d) to the control capacitor C103 through the resistor R103, and makes the voltage across the control capacitor C103 vary by the on-duty of the PWM signal. Specifically, during the preheating operation from t1 to t2, the PWM signal is stopped (in other words, setting the on-duty to 0), and in the regular operation from t3 to t4, the on-duty is set higher than that of the starting operation from t2 to t3, whereby the voltage across the control capacitor C103 is increased gradually, namely, the operating frequencies f1 to f3 are decreased gradually as shown in FIG. 6(f). That is, the operating frequency is set to a highest operating frequency f1 in the preheating operation from t1 to t2, is set to a lower operating frequency f2 in the preheating operation from t1 to t2 compared to the starting operation from t2 to t3, and is set to a further lower operating frequency f3 from t3 to t4.

The output of the sequence control circuit 41 is not restricted to a PWM signal, but may be any signal that makes the voltage across the control capacitor C103 vary. As compared with the resonant frequency of the resonant circuit including the discharge lamp La, being connected across switch Q3 in a low side of the power conversion circuit 2, the operating frequencies f1 to f3 are set to be high, namely, with decreasing operating frequencies f1 to f3, power supplied from the power conversion circuit 2 to the discharge lamp La increases. That is, the output power to the discharge lamp La increases gradually due to the gradual decrease of the operating frequencies f1 to f3 as described above. Moreover, the time t2 at which the starting operation from t2 to t3 is started and time t3 at which regular operation from t3 to t4 is started are determined, respectively, for example, by a time check, and the duration of the preheating operation from t1 to t2 and duration of the starting operation from t2 to t3 are set to be almost constant, respectively.

Moreover, the shutdown execution circuit 34 does not make the operation of the drive circuit 31 start in a predetermined shutdown time T1 after an output of the control voltage Vcc1 to the control IC 4 is started. Therefore, the time at which the preheating operation from t1 to t2 is started shall be after the predetermined time T1 has elapsed after the output of the control voltage Vcc1 to the control IC 4 is started. Because the shutdown time T1 is set long to such a degree as enabling sufficient discharging of the control capacitor C103, even if the repeated starting is performed immediately after the regular operation from t3 to t4 is stopped, sufficient discharging of the control capacitor C103 is performed during the shutdown time T1 before start of the next preheating operation from t1 to t3 is performed. Therefore, the output power from the power conversion circuit 2 to the discharge lamp La does not become excessive at a start time t1 of the preheating operation from t1 to t2.

The control IC 4 may be provided with a shutdown control circuit 42 connected to the shutdown execution circuit 34. The circuit connection from shutdown control circuit 42 of the control IC 4 to the shutdown execution circuit 34 of the drive IC 3 is connected to the control voltage Vcc1 through resistor R51. The shutdown control circuit 42 is normally set low equal to ground and, when shutting down operation of the drive circuit 31, directs the shutdown of the drive circuit 31 by setting the circuit to a high level equal to the control voltage Vcc1. That is, in a period of time when the shutdown of the drive circuit 31 is directed, no current flows in the resistor R51 and no power is consumed. Therefore, the power consumption is decreased compared with a configuration where current always flows in resistor R51.

In a period of time when the output of the shutdown control circuit 42 is high, the shutdown execution circuit 34 does not operate the drive circuit 31. In the example of FIG. 6, from the start of the output of the control voltage Vcc1 until a completion time t4 of the regular operation from t3 to t4, the input of the shutdown execution circuit 34 (namely, the output of the shutdown control circuit 42) is maintained low, whereby the preheating operation from t1 to t2 is started after the lapse of the shutdown time T1 after the output of the control voltage Vcc1 is started. However, when, after the output of the control voltage Vcc1 is started, the input to the shutdown execution circuit 34 becomes high and subsequently changes to low, the preheating operation from t1 to t2 is started after the elapse of the shutdown time T1 after the input to the shutdown execution circuit 34 becomes low. That is, strictly, at a time when a state where the control voltage Vcc1 is supplied from the control power supply circuit 33 and the input to the shutdown execution circuit 34 is low is continued only for the shutdown time T1, the preheating operation from t1 to t2 is started, and a shutdown of at least the shutdown time T1 is secured between a time when the regular operation from t3 to t4 is completed and a time when the preheating operation from t1 to t2 is next started.

Furthermore, the present embodiment may be equipped with a power supply detection circuit 61 for outputting a DC voltage according to a voltage obtained by smoothing the output voltage of the rectification circuit DB, and a DC power supply detection circuit 62 that includes, for example, the voltage dividing resistor for dividing an output voltage of the DC power supply circuit 1 and outputs a higher voltage with increasing output voltage of the DC power supply circuit 1.

Moreover, the drive IC 3 of the present embodiment may be provided with a circuit for driving a switch Q1 of the DC power supply circuit 1. Explaining in detail, the drive IC 3 may be provided with an error amplifier OP4 for outputting a voltage according to a difference between a predetermined seventh reference voltage Vr7 and an output voltage of the DC power supply detection circuit 62; a multiplier circuit 36a for multiplying an output of the power supply detection circuit 61 and an output of the error amplifier OP4, a comparator CP7 with an inverting input coupled to the output of the multiplier circuit 36a and with a non-inverting input connected to a junction point of the switch Q1 of the DC power supply circuit 1 and the resistor R5, a flip-flop circuit 36b having a reset terminal connected to an output of the comparator CP7; and a power supply drive circuit 36c that is connected to the switch Q1 of the DC power supply circuit 1 through a resistor R4 and drives the switch Q1 of the DC power supply circuit 1 according to an output of the flip-flop circuit 36b.

Furthermore, the inductor L1 of the DC power supply circuit 1 is provided with the secondary winding with one end is connected to ground and the other end connected to a zero current detection circuit 36d provided in the drive IC 3. The zero current detection circuit 36d is connected to a set terminal of a flip-flop circuit 36c, detects completion of energy release of the inductor L1 based on a voltage induced in the secondary winding, and, when the completion of energy release of the inductor L1 is detected, inputs a pulse to a set terminal of the flip-flop circuit 36b.

Accordingly, switch Q1 of the DC power supply circuit 1 is periodically turned on and off, and its on-duty time is feedback controlled so that the output voltage of the DC power supply circuit 1 may become a predetermined target voltage. This target voltage is specified to be a voltage that equalizes the output voltage of the DC power supply detection circuit 62 to the seventh reference voltage Vr7.

Furthermore, the present embodiment is equipped with a lamp end life detection circuit 63 that detects a parameter that changes at lamp end of life and outputs a voltage according to the detected parameter. Specifically, the lamp end of life detection circuit 63 of the present embodiment detects asymmetrical currents generated in the discharge lamp La as one parameter, and outputs a voltage according to detection.

Moreover, the control IC 4 is provided with a lamp end of life detection circuit 43 that determines whether the discharge lamp La is in an end-of-life state, that is a fault condition of being at end of life based on an output of the end of life detection circuit 63 and provides an output according to the detection result to the shutdown control circuit 42. That is, the discharge lamp end of life detection circuit 43 may be considered a load side fault detection circuit

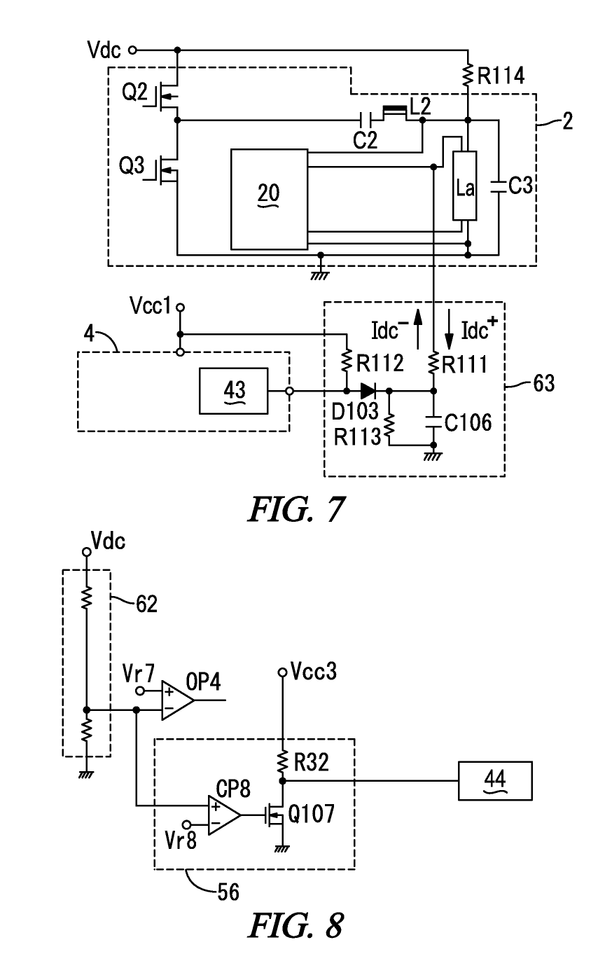

Explaining in detail, as shown in FIG. 7, the end of life detection circuit 63 is provided with a parallel circuit of a capacitor C106 and a resistor R113, one end of the parallel circuit being connected to the inductor L2 through a resistor R111 and one of the filaments of the discharge lamp La, and the other end of the parallel circuit being connected to ground. Moreover, the capacitor C106 is connected to the end of life detection circuit 43 through a diode D103 having its cathode connected to capacitor C106 in a forward direction. The junction point of the anode of diode D103 and the end of life detection circuit 43 is connected to the output end (control voltage Vcc1) of the control power supply circuit 33 through a resistor R112.

When the discharge lamp La is not at the end of its life, during lighting of the discharge lamp La, current from the power conversion circuit 2 to the end of life detection circuit 63 (hereinafter called an “incoming current”) Idc+ and a current from the end of life detection circuit 63 to the power conversion circuit 2 (hereinafter called an “outgoing current”) Idc− become substantially equal to each other. Thereby, a voltage across the capacitor C106 of the end of life detection circuit 63, i.e., an output voltage of the end of life detection circuit 63 is maintained to be a substantially constant voltage (hereinafter called a “normal voltage”) and this normal voltage will be one that is obtained by dividing the control voltage Vcc1 with the resistors R112, R113. The junction point of the inductor L2 of the power conversion circuit 2 and the discharge lamp La is connected to the high-voltage side output end of the DC power supply circuit 1 through a resistor R114.

On the other hand, because the degradation of lamp emission differs for every filament at the end of life of the discharge lamp La, one of the above-mentioned currents Idc+, Id− becomes larger than the other (namely, asymmetrical currents arise), and a difference according to the difference of the currents Idc+, Id− (magnitudes of the asymmetrical currents) arises between the output voltage of the end of life detection circuit 63 and the normal voltage. For example, when the outgoing current Idc+ is larger than the incoming current Idc−, the output voltage of the end of life detection circuit 63 becomes higher than the normal voltage. Conversely, when the outgoing current Idc+ is smaller than the incoming current Idc−, the output voltage of the end of life detection circuit 63 becomes lower than the normal voltage.

The end of life detection circuit 43 compares the output voltage of the end of life detection circuit 63 with a predetermined upper limit voltage that is higher than the normal voltage and a predetermined lower limit voltage that is lower than the normal voltage. If the output voltage of the end of life detection circuit 63 is equal to or less than the upper limit voltage or equal to or more than the lower limit voltage, it is determined that the lamp is not in an end-of-life state. If the output voltage of the end of life detection circuit 63 exceeds the upper limit voltage or is less than the lower limit voltage, it is determined that the lamp is in an end-of-life state. For example, when the control voltage Vcc1 is 5V and the normal voltage is 2.5V, the upper limit voltage is set to 4V and the lower limit voltage is set to 1V.

Furthermore, the drive IC 3 may be provided with a DC voltage droop detection circuit 37 that determines whether the DC power supply circuit 1 is in a fault condition where its output voltage is insufficient (hereinafter called a “DC voltage droop state”) based on an output of the DC power supply detection circuit 62 and outputs a voltage depending on the detection result. That is, the DC voltage droop detection circuit 37 may be considered a supply side fault detection circuit.

As shown in FIG. 8, the DC voltage droop detection circuit 37 may include a comparator CP8 having a non-inverting input coupled to the output voltage of the DC power supply detection circuit 62 and an inverting input coupled to a predetermined eighth reference voltage Vr8 that is lower than the seventh reference voltage Vr7. A switch Q107, which may be an n-channel type FET, has its gate connected to the output of comparator CP8. The switch Q107 is also connected to ground at one terminal and is provided with the signal voltage Vcc3 at the other terminal through a resistor R32. A junction point of switch Q107 and resistor R32 is connected to the control IC 4 as an output end of the DC voltage droop detection circuit 37.

The eighth reference voltage Vr8 is set to 50% to 80% of the seventh reference voltage Vr7 corresponding to the target voltage. That is, when the output voltage of the DC power supply detection circuit 62 is equal to or greater than the eighth reference voltage Vr8, the DC voltage droop detection circuit 37 does not determine the DC voltage droop state and sets the output to low. When the output voltage of the DC power supply detection circuit 62 is lower than the eighth reference voltage Vr8, it determines the DC voltage droop state and sets the output to high. For example, in the case where the eighth reference voltage Vr8 is defined to be 80% of the seventh reference voltage Vr7, when the output voltage of the DC power supply circuit 1 becomes less than about 80% of the target voltage, a DC voltage droop state is determined.

Moreover, the control IC 4 is provided with a detection input circuit 44 that appropriately converts an output of the DC voltage droop detection circuit 37 and inputs it to the shutdown control circuit 42.

The shutdown control circuit 42 of the present embodiment refers to an output of the end of life detection circuit 43 and an output of the detection input circuit 44 at all times, and, if the end-of-life state is determined by the end of life detection circuit 43, sets the output to the drive IC 3 to high, stops the drive circuit 31 of the drive IC 3 and the others, and at the same time stops the sequence control circuit 41.

Moreover, when the DC voltage droop state is determined by the DC voltage droop detection circuit 37, the shutdown control circuit 42 does not shutdown the drive circuit 31 and the sequence control circuit 41 immediately as described above, but controls the sequence control circuit 41 so as to perform the starting operation only for a predetermined restart time T5 (refer to FIG. 10). If the DC voltage droop state is still determined after elapse of the restart time T5, shutdown circuit 42 stops the drive circuit 31 of the drive IC 3 and the others at that time by setting the output to the drive IC 3 to high similarly as when the end-of-life state is determined and at the same time stops the sequence control circuit 41.

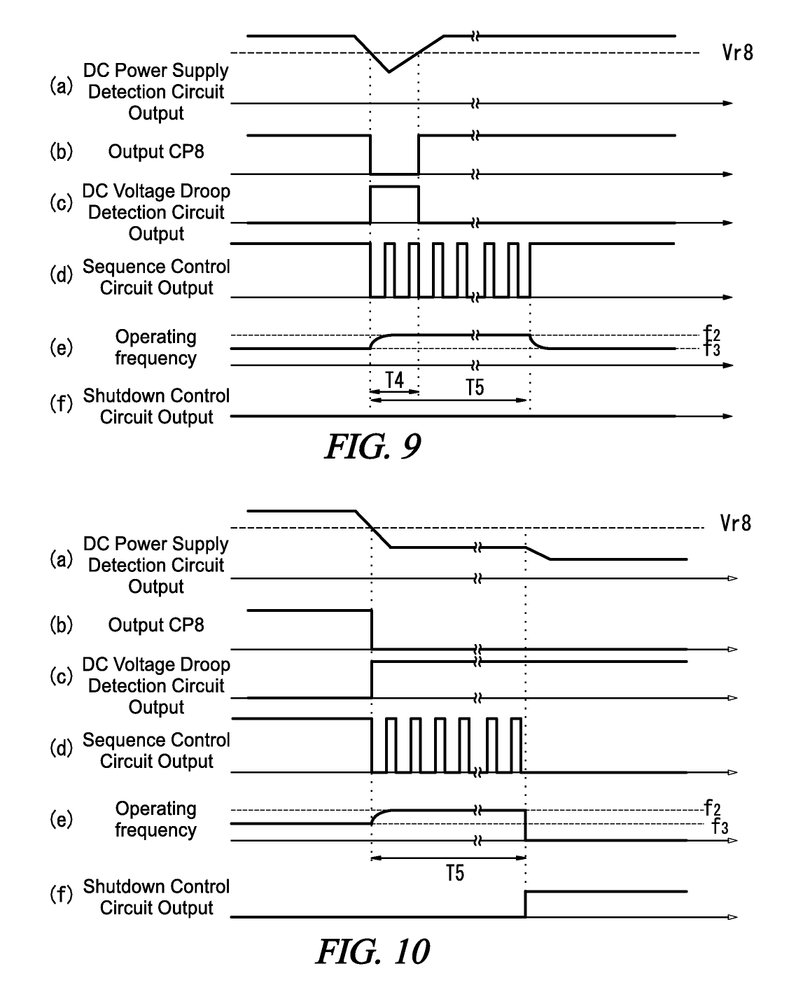

FIGS. 9 and 10 show operation of the present embodiment when the DC voltage droop state is determined. In each of FIG. 9 and FIG. 10, (a) shows a temporal variation in the output voltage of the DC power supply detection circuit 62, (b) shows a temporal variation in the output of the comparator CP8 of the DC voltage droop detection circuit 37, (c) shows a temporal variation in the output of the DC voltage droop detection circuit 37, (d) shows a temporal variation in the output of the sequence control circuit 41, (e) shows a temporal variation in the operating frequency, and (f) shows a temporal variation in the output of the shutdown control circuit 42 directed to the drive IC 3. In the example of FIG. 9, because the DC voltage droop state (namely, a state where the DC voltage droop detection circuit is high) has completed in a time T4 shorter than the restart time T5, shutdown by the shutdown control circuit 42 is not performed, and regular operation is restarted after the lapse of the restart time T5. Moreover, FIG. 10 shows operation in a case where, since a duration of the DC voltage droop state equaled the restart time T5, shutdown by the shutdown control circuit 42 is performed. In the present embodiment, the shutdown execution circuit 34 of the drive IC 3 also disables power supply drive circuit 36c when the output of the shutdown control circuit 42 becomes high. After completion of the starting operation that is continued only for the restart time T5 in FIG. 10, the output voltage of the DC power supply circuit 1 and the output voltage of the DC power supply detection circuit 62 are decreased by the shutdown of the power supply drive circuit 36c.

Incidentally, in the case where the drive circuit 31 and the power supply drive circuit 36c are immediately shut down when the DC voltage droop state is determined, even if the DC voltage droop state is caused, for example, by instantaneous power failure and is eliminated in a short time, it is impossible to start the discharge lamp La.

In contrast to this, in the present embodiment, when the DC voltage droop state is determined as described above, by the starting operation being performed only in the restart time T5, when the discharge lamp La goes out by the short-time DC voltage droop state as described above, it is possible to restart the discharge lamp La again. Moreover, when the DC voltage droop state is determined after the completion of the starting operation of the above-mentioned restart time T5, the drive circuit 31 and the power supply drive circuit 36c are shut down, and therefore, even when the output of the DC power supply detection circuit 62 becomes always 0V, not reflecting the output voltage of the DC power supply circuit 1 due to a failure, for example, such as short circuit, it is possible to avoid excessive electrical stresses on the circuit elements and the discharge lamp La by erroneous feedback control.

Moreover, it is considered that, when the DC voltage droop state occurs, the lamp current becomes temporarily asymmetric in combination with flickering or extinguishing of the discharge lamp La, and consequently an end-of-life state is erroneously determined. If the drive circuit 31 and the power supply drive circuit 36c are shutdown by such an erroneous detection of the end-of-life state, the starting operation by the detection of the DC voltage droop state as described above will not be substantially performed. Avoiding the erroneous detection caused by lamp extinguishing as described above is possible, for example, by sufficiently separating the operating frequency from the resonance frequency of the resonant circuit that the power conversion circuit 2 and the discharge lamp La constitute, thereby securing a so-called delay phase side operation. However, if this occurs, circuit loss will increase due to an increase in reactive current.

In view of this fact, when both the end-of-life state and the DC voltage droop state are determined, the shutdown control circuit 42 of the present embodiment prioritizes operation by the detection of the DC voltage droop state and does not perform any operation according to the detection of the end-of-life state in a period of time when the DC voltage droop state is determined. Thereby, the drive circuit 31 is not shut down by the erroneous detection of the end-of-life state when the discharge lamp La is extinguished.

Moreover, the control IC 4 of the present embodiment is provided with a clock circuit 45 for generating a periodic clock signal, and with increasing frequency of the clock signal, the power consumption of the control IC 4 increases, On the other hand, at least the operation speed of the shutdown control circuit 42 becomes higher, and consequently fault response becomes faster. In the present embodiment, speed of response to the end-of-life state and the DC voltage droop state is preferred during normal operation. Therefore, a configuration in which the clock frequency TB during regular operation from t3 to t4 is set higher than the clock frequency TA in other periods, as shown in FIG. 16(g), is employed. Thereby, while in regular operation from t3 to t4, by the clock frequency being set to the higher frequency TB, a high response speed is secured. During a shutdown of the drive circuit 31, by the clock frequency being set to the low frequency TA, and thereby by the power consumption being reduced, it is possible to reduce stresses imposing on the starting circuit 32 and to stabilize the driving voltage Vcc2.

Note here that the clock frequency is only required to be the high frequency TB during regular operation from t3 to t4, and the time at which the clock frequency is switched from the low frequency TA to the high frequency TB is not restricted to a start time t3 in regular operation from t3 to t4, as shown in FIG. 6(g). Therefore, the clock frequency may be switched at other times in a period from a start time t2 of the preheating operation from t1 to t2 to the start time t3 of the regular operation from t3 to t4.

It is acceptable to adopt a configuration in which a counting circuit (not illustrated) for counting the number of times by which the sequence control circuit 41 performs a repeated starting operation by the detection of the DC voltage droop state is provided, and after the count reaches a predetermined upper limit (e.g., 5 times), even when the DC voltage droop state is determined, the sequence control circuit 41 does not start the starting operation, and the shutdown control circuit 42 stops the drive circuit 31 etc. by setting the output to high.

Moreover, the load is not restricted to the discharge lamp La, but may be a device such that power supplied thereto at device start-up should be increased gradually.

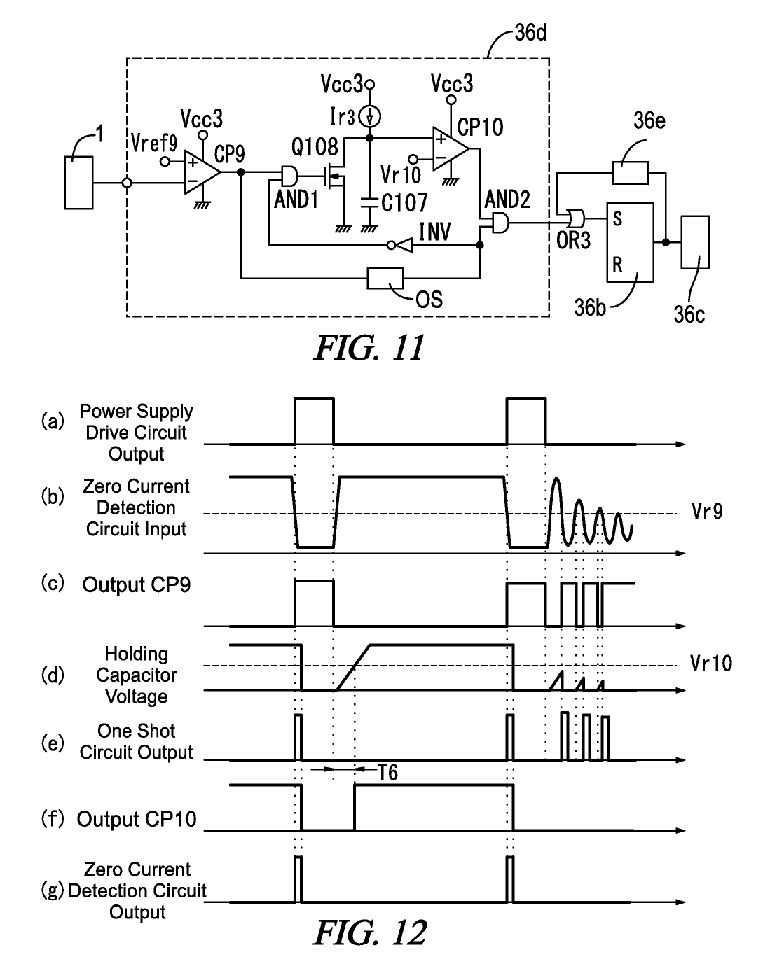

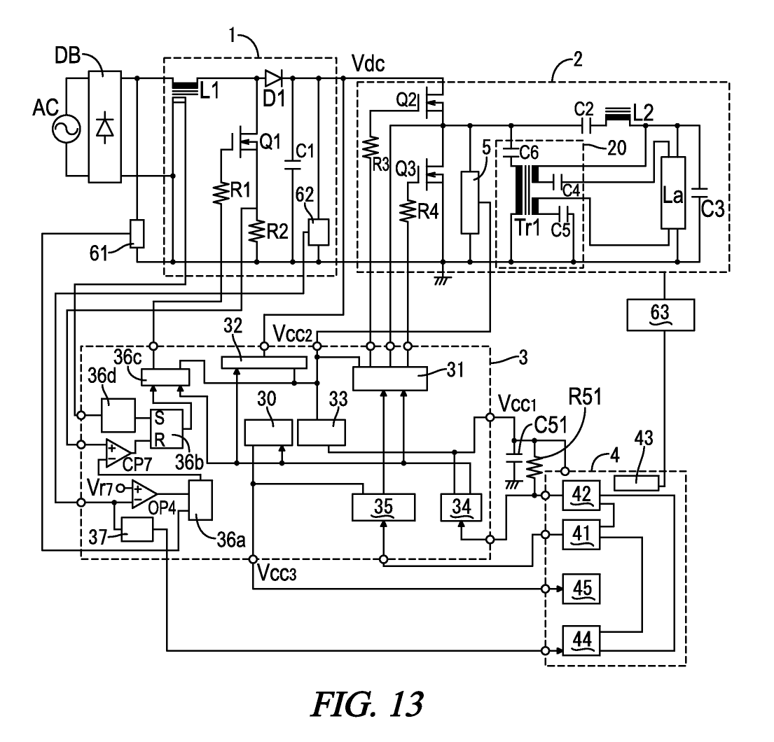

Furthermore, the zero current detection circuit 36d may be configured as shown in FIG. 11. Explaining in detail, the zero current detection circuit 36d may include an input comparator CP9 having an inverting input connected to the secondary winding of the inductor L1 of the DC power supply circuit 1, and a non-inverting input coupled to a predetermined ninth reference voltage Vr9. When the output of the input comparator CP9 transitions from low to high, a one shot circuit OS provides a starting output of a pulse with a predetermined width. A NOT gate INV inverts the output of the one shot circuit OS. A first AND gate AND1 outputs a logical product of the output of the input comparator CP9 and the output of the NOT gate INV. A holding C107 is charged by a constant current source Ir3 using the control voltage Vcc1 as a power supply. A switch Q108, such as an n-channel type FET, is connected in parallel with holding capacitor C107. The gate of switch Q108 is connected to the output of first AND gate AND1. An output comparator CP10 has its inverting input coupled to a predetermined 10th reference voltage Vr10 and a non-inverting input connected to the holding capacitor C107. A second AND gate AND2 outputs a logical product of the output of the output comparator CP10 and the output of the one shot circuit OS as an output to the zero current detection circuit 36d.

Operation of the zero current detection circuit 36d of FIG. 11 will be explained with reference to FIG. 12. When an input voltage from the secondary wiring of the inductor L1 of the DC power supply circuit 1 to the zero current detection circuit 36d varies as shown by FIG. 12(b), the output of the input comparator CP9 is shown by FIG. 12(c), and the output of the one shot circuit OS becomes is shown by FIG. 12(e). Because the holding capacitor C107 is rapidly discharged through switch Q108 when the output of the first AND gate AND1 becomes high, it is charged in a period of time when the output of the first AND gate AND1 is low, i.e., a period of time when the output of the input comparator CP9 is low and in a period of time when the output of the one shot circuit OS is high, and increases the output voltage to the output comparator CP10 gradually. The period when the output of the zero current detection circuit 36d becomes high as shown by FIG. 12(g) is a period when the output of the one shot circuit OS is high and the output of the comparator CP10 is high, i.e., a period equal to a pulse width of the output of the one shot circuit OS immediately before an output of the output comparator CP10 shown by FIG. 12(f) changes from high to low. Thereby the output of the power supply drive circuit 36c is shown in FIG. 12(a). Because the output of the zero current detection circuit 36d does not become high as long as the output of the output comparator CP10 does not become high, in a predetermined holding time T6 after an input voltage to the zero current detection circuit 36d falls below the ninth reference voltage Vr9. Until the voltage across the holding capacitor C107 reaches the tenth reference voltage Vr10, the output of the zero current detection circuit 36d does not become high. In other words, unless the duration when the input voltage to the zero current detection circuit 36d is less than the ninth reference voltage Vr9 equals the holding time T6, the output of the flip-flop circuit 36b does not become high, and therefore switch Q1 of the DC power supply circuit 1 is not turned on.

In the DC power supply circuit 1, depending on the reverse recovery time of the parasitic impedance or diode D, immediately after switch Q1 is turned on, a current (hereinafter called a “reverse flow current”) flows from the output capacitor C1 into detection resistor R3. Moreover, in the drive IC 3, an input voltage to the inverting input of the comparator CP7 connected to the reset terminal of the flip-flop circuit 36b decreases when the voltage (hereinafter called as an “input power supply voltage”) provided from the AC power supply AC decreases. When the input power supply voltage becomes low relative to the reverse flow current and the output of the above-mentioned comparator CP7 becomes high, even when energy is not sufficiently accumulated in the inductor L1, switch Q1 will turn off. In this case, although switch Q1 is turned on again in a very short time, the switch Q1 is turned on and off in a short cycle by this repeated action. If switch Q1 is turned on and off in a short cycle like this, excessive electric stress will be imposed on switch Q1.

In contrast to this, in the embodiment of FIG. 11, as described above, because the duration when the input voltage to the zero current detection circuit 36d is less than the ninth reference voltage Vr9 equals the holding time T6, switch Q1 is not turned on, namely, an off state of the switch Q1 continues at least only for the holding time T6, even if the input voltage of the zero current detection circuit 36d varies slightly as shown toward the right side of FIG. 12. Thus, a situation where the life of the switch Q1 is reduced by short cycling on/off and the like can be avoided.

Furthermore, in the example of FIG. 11, the output of the zero current detection circuit 36d is connected to the set terminal of the flip-flop circuit 36b through an OR gate OR3, and the drive IC 3 is provided with a restart circuit 36e that monitors the output of the flip-flop circuit 36b and, when the output of the flip-flop circuit 36b continues to be low for a predetermined time (e.g., 100 μs) or more, inputs a pulse to the set terminal of the flip-flop circuit 36 through the OR gate OR3.

The shutdown execution circuit 34 of the present embodiment determines droop of in the input power supply voltage based on an output of the power supply detection circuit 61, and, if the droop in the input power supply voltage is determined, stops the drive circuit 31 and the signal power supply circuit 30 by setting the output to low similarly as when the output of the shutdown control circuit 42 becomes high.

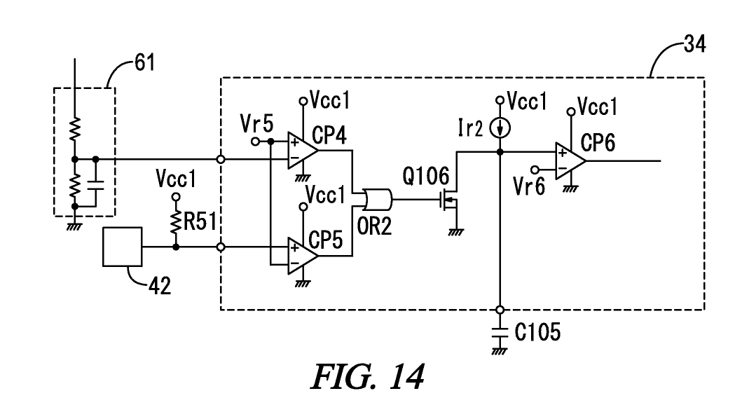

Specifically, the power supply detection circuit 61 divides the output voltage of the rectifier DB with voltage dividing resistors, as shown in FIG. 14, and outputs a DC voltage that is smoothed with a capacitor. Moreover, the shutdown execution circuit 34 includes an input comparator CP4 having a non-inverting input coupled to a predetermined fifth reference voltage Vr5 and an inverting input connected with an output voltage of the power supply detection circuit 61. An input comparator CP5 has a non-inverting input connected to the shutdown control circuit 42 and an inverting input coupled to the fifth reference voltage Vr5. An OR gate OR2 outputs a logical sum of the outputs of the two input comparators CP4, CP5. A constant current source Ir1 charges the delay capacitor provided in the outside of the drive IC 3. A switch Q106, which may be an n-channel type FET, is connected in parallel with the delay capacitor C105. The gate of switch Q106 is connected to the output of OR gate OR2. An output comparator CP6 has its non-inverting input coupled to the delay capacitor C105 and an inverting input coupled to the sixth reference voltage Vr6. A period when the output of output comparator CP6 becomes high is exactly a period when the drive circuit 31 and the signal power supply circuit 30 operate, i.e., a period when the signal voltage Vcc3 is outputted.

Operation of the shutdown execution circuit 34 can now be explained. Because the shutdown execution circuit 34 uses the control voltage Vcc1 from the control power supply circuit 33 as a power supply, at the starting time, charging of the delay capacitor C105 is started with output start of the control voltage Vcc1 from the control power supply circuit 33. When the voltage across the delay capacitor C105 reaches a sixth reference voltage Vr6, the output of the output comparator CP6 becomes high, which starts the operation of the drive circuit 31 and an output of the signal voltage Vcc3. At this time, in the starting circuit 32, the switch Q101 is fixed in an off state. That is, a charging time T2 obtained by dividing a product of a capacitance of the delay capacitor C105 and the sixth reference voltage Vr6 by an output current of the constant current source Ir1 of the shutdown execution circuit 34 exactly agrees with the shutdown time T1.

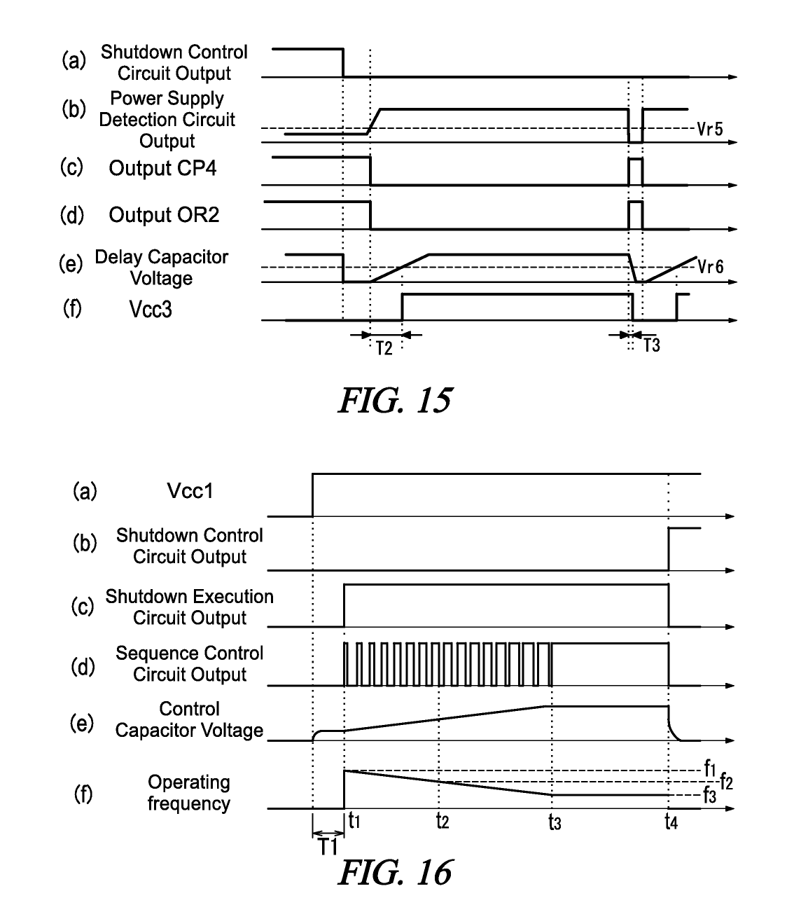

Moreover, when the output voltage of the power supply detection circuit 61 falls below the fifth reference voltage Vr5, or when the output of the shutdown control circuit 42 becomes high, by the output of either of the input comparators CP4, CP5 becoming high, and thereby by the switch Q106 being turned on, the delay capacitor C105 is rapidly discharged through the switch Q106. By the voltage across the delay capacitor C105 being less than the sixth reference voltage Vr6, and thereby by the output of the output comparator CP6 becoming low, the drive circuit 31 and the signal voltage Vcc3 are shut down. Here, a time period between a time when the switch Q106 is turned off and a time when the output of the output comparator CP6 becomes low (hereinafter, called a “holding time”) T3 (refer to FIG. 15) becomes sufficiently short.

FIG. 15 shows one example of operation of the present embodiment. In the example of FIG. 15, when the output of the shutdown control circuit 42 shown in FIG. 15(a) becomes low, the output voltage of the power supply detection circuit 61 shown in FIG. 15(b) is less than the fifth reference voltage Vr5. Thereby the output of the one input comparator CP4 shown in FIG. 15(c) is high, and therefore the output of the OR gate 2 shown in FIG. 15(d) is also high. In a short time, when the output voltage of the power supply detection circuit 61 exceeds the fifth reference voltage Vr5, the output of the OR gate OR2 becomes low, and switch Q106 is turned off, which starts the charging of delay capacitor C105. Further, when the charging time T2 elapses and the voltage across delay capacitor C105 reaches the sixth reference voltage Vr6, the output of output comparator CP6 becomes high and the drive circuit 31 and the output of the signal voltage Vcc3 shown in FIG. 15(f) are started. After that, when the output voltage of the power supply detection circuit 64 decreases and is less than the fifth reference voltage Vr5, the output of output comparator CP6 becomes low in a very short holding time T3; and at this state, the operation of the drive circuit 31 and the output of the signal voltage Vcc3 are shut down, respectively.

Moreover, in the present embodiment, as shown in FIG. 16, the sequence control circuit 41 makes the on-duty time of the PWM signal (FIG. 16(d)) provided to the oscillation circuit 35 gradually larger continuously from the start time t1 of the preheating operation from t1 to t2 until a completion time t3 of the starting operation from t2 to t3. Thereby, the voltage across the control capacitor C103 shown in FIG. 16(e) becomes large linearly over the period from t1 to t3. The operating frequency shown in FIG. 16(f) is lowering linearly from the operating frequency f1 at the start time t1 of the preheating operation from t1 to t2 to an operating frequency f3 in the regular operation from t3 to t4.

A basic configuration of the present embodiment is common to that of the second embodiment, and therefore any circuit common thereto is given a same reference numeral and its detailed illustration and explanation are omitted.

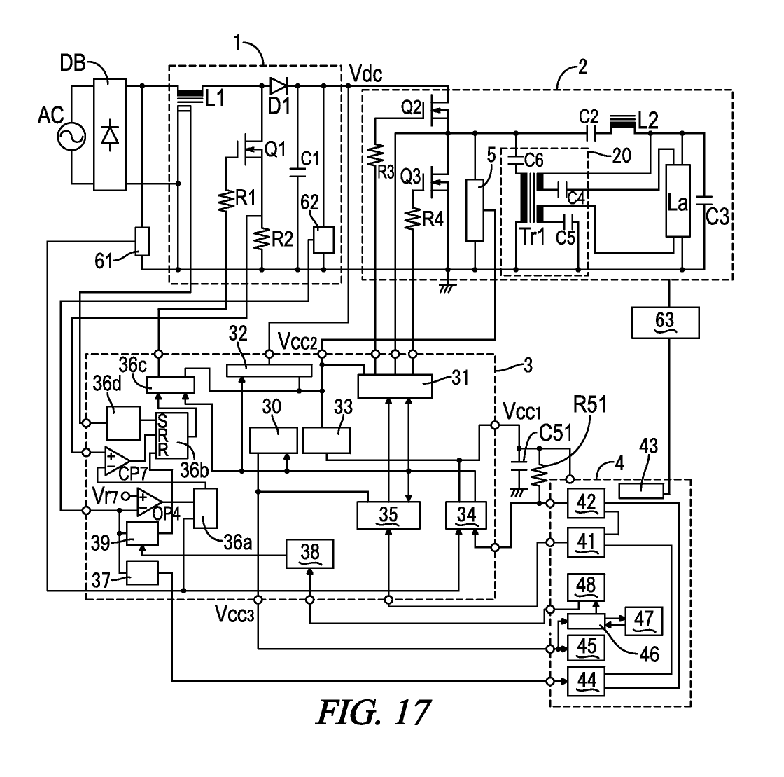

In the present embodiment, as shown in FIG. 17, the drive IC 3 is provided with an over-voltage protection circuit 39 that determines whether a state is an over-voltage state where the output voltage Vdc of the DC power supply circuit 1 becomes abnormally high, and when the over-voltage state is determined, lowers the output voltage of the DC power supply circuit 1.

Moreover, the control IC 4 is provided with a timer circuit 46 for measuring a cumulative time when the electronic ballast is used. A storage circuit 47 such as a nonvolatile memory holds the cumulative ballast usage time at least in a period of time when the power supply is being turned off. A signal circuit 48 sets the output to low until the cumulative usage time checked by the timer circuit 46 amounts to a predetermined unit lifetime that is considered a life of the electronic ballast, and sets the output to high after the cumulative usage time amounts to the unit life time. The cumulative droop time is measured, for example, in a period of time when the signal voltage Vcc3 from the drive IC 3 is being provided (namely a period when the drive circuit 31 is in operation).

Furthermore, the drive IC 3 may be provided with a signal input circuit 38 to which an output of the signal circuit 48 is provided. The signal input circuit 38 is connected to the over-voltage protection circuit 39, and the over-voltage protection circuit 39 changes its operation according to the output of the signal circuit 48.

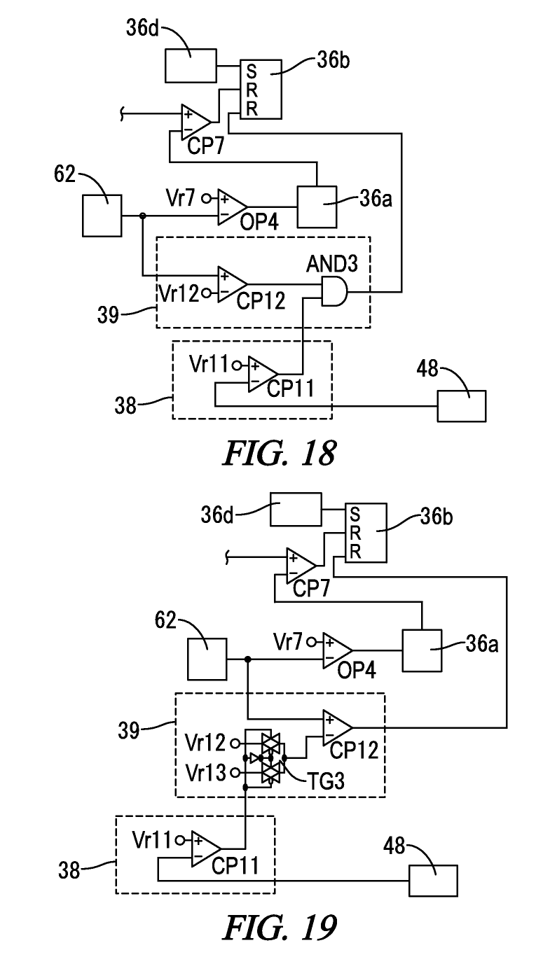

Explaining in detail, as shown in FIG. 18, the signal input circuit 38 is can include a comparator CP11 having an inverting input connected to the signal circuit 48, a non-inverting input coupled to a predetermined 11th reference voltage Vr11, and an output is connected to the inverting input of the control operational amplifier OP2 through a resistor R33. The 11th reference voltage Vr11 is set lower than a voltage value of the high output of signal circuit 48, and is set higher than a voltage value of the low output of signal circuit 48. That is, the signal input circuit 38 acts as a NOT gate, and the output of the signal input circuit 38, i.e., the output of comparator CP11 is the output of the signal circuit 48 being inverted.

The over-voltage protection circuit 39 may include a comparator CP12 having a non-inverting input coupled to the output of the DC power supply detection circuit 62 and an inverting input coupled to a predetermined 12th reference voltage Vr12. An AND gate AND3 outputs a logical product of the output of comparator CP12 and the output of the signal input circuit 38 to the reset terminal of the flip-flop circuit 36b. That is, when the cumulative usage time does not amount to the unit life time, at a time when the output voltage of the DC power supply detection circuit 62 exceeds the 12th reference voltage, switch Q4 of the DC power supply circuit 1 is turned off, and thereby an over-voltage protection operation of lowering the output voltage Vdc of the DC power supply circuit 1 is performed. After the cumulative usage time equals the unit life time, by the output of the signal input circuit 38 becoming low, the output of the AND gate AND3 is fixed to low and the over-voltage protection operation is no longer performed.

According to the above-mentioned configuration, after the cumulative usage time reaches the unit life time, the over-voltage protection operation is not performed, and thereby e switch Q4 of the DC power supply circuit 1 becomes susceptible to be affected by a high electrical stresses. Therefore, a possibility that the switch Q4 fails prematurely becomes high. This can be managed by conventional means such as a fuse (not illustrated) etc. In addition, the time when switch Q4 may fail varies, even among a plurality of electronic ballasts used simultaneously.

The over-voltage protection circuit 39 is not restricted to what is described above. For example, instead of providing the AND gate AND3, for example, as shown in FIG. 19, the 12th reference voltage Vr12 and a 13th reference voltage Vr13 higher than the 12th reference voltage Vr12 may be provided to a non-inverting input of the comparator CP12 through a multiplexer TG3 constructed with transfer gate circuits, respectively. During a period of time when the output of the signal circuit 48 is high, the voltage provided to the inverting input of comparator CP12 of the over-voltage protection circuit 39 is specified to be the 13th reference voltage higher than the 12th reference voltage Vr12. This configuration enables a similar effect to be obtained through a process where after the cumulative usage time reaches the unit life time, the voltage provided to the non-inverting input of comparator CP12 becomes higher, and the over-voltage protection operation is more difficult to perform.

Thus, although there have been described particular embodiments of the present invention of a new and useful fault detection and shutdown control circuits and methods for electronic ballasts, it is not intended that such references be construed as limitations upon the scope of this invention except as set forth in the following claims.

What is claimed is:

1. A electronic ballast comprising:
a DC power supply circuit that, when supplied with electric power from an external power supply, is functional to output DC power;
a power conversion circuit coupled to the DC power circuit and is operable to convert the DC power from the DC power supply circuit and output it to a load;
a supply side fault detection circuit coupled to the DC power supply circuit and functional to determine an existence or absence of a fault condition in the DC power supply circuit;
a load side fault detection circuit coupled to the power conversion circuit and functional to determine the existence or absence of a fault condition in either of the power conversion circuit and the load;
a control circuit operably coupled to the power conversion circuit, to the supply side fault detection circuit, and to the load side fault detection circuit, and functional to control the power conversion circuit in response to fault detection by the supply side fault detection circuit and fault detection by the load side fault detection circuit; and wherein
the control circuit is functional to cause a reduction in output power from the power conversion circuit to the load to be smaller than that in a regular operation at a starting time,
when the supply side fault detection circuit determines a fault condition, the control circuit performs a repeated starting operation for a predetermined time; and
when the load side fault detection circuit determines a fault condition, the control circuit stops at least an output of the power conversion circuit only when the supply side fault detection circuit does not determine a fault condition.

2. The electronic ballast of claim 1, wherein, after a fault condition is determined by the supply side fault detection circuit, if the fault condition is still determined by the supply side fault detection circuit at the time of completion of the repeated starting operation, the control circuit stops at least the output of the power conversion circuit.

3. The electronic ballast according to either claim 1 or claim 2, wherein the control circuit counts a number of times of performing the repeated starting operation, and, when the supply side fault detection circuit determines the fault condition after the number of times of starting the repeated starting operation reaches a predetermined upper limit number, stops at least the output of the power conversion circuit without starting the repeated starting operation.
